(19) United States
(12) Patent Application Publication
(10) Pub. No.: US 2009/0100038 A1
(43) Pub. Date: Apr. 16, 2009

(54) Information Analysis System

(76) Inventor: Woo Hyoung Lee, Seoul (KR)

Correspondence Address: Anthony G. Fussner, Suite 400, 7700 Bonhomme, St. Louis, MO, 63105, US

(21) Appl. No.: 11/953,574

(22) Filed: Dec. 10, 2007

(30) Foreign Application Priority Data
Oct. 10, 2007 (KR) 10-2007-0102222

(51) Int. Cl. G06F 17/30; G06F 7/00; G06F 17/00

(52) U.S. Cl. 707/5; 707/100; 715/211; 707/E17.084

(57) ABSTRACT

An information analysis system is provided, which includes a data loading unit to retrieve data from a document, a storage unit to store the data, a correlation analysis unit to compute at least one correlation index to represent the correlation between the data stored at the storage unit, and a mapping unit to show the correlation between the data on a map based on the correlation index. As a result, technical trends or prospect technology are analyzed.

### CROSS-REFERENCE TO RELATED APPLICATION

This application claims priority from Korean Patent Application No. 10-2007-0102222, filed Oct. 10, 2007 in the Korean Intellectual Property Office, the entire disclosure of which is hereby incorporated by reference.

### FIELD

The present invention generally relates to an information analysis system and a method for analyzing information, and more particularly, to an information analysis system and method for analyzing information such as technology developments, emerging technologies, world renowned researchers and laboratories, international cooperation, or compatibility with other technical fields, by deriving new information and knowledge based on quantitive data analysis.

### BACKGROUND

The statements in this section merely provide background information related to the present disclosure and may not constitute prior art.

As winner-takes-all philosophy has become prevalent in global society, more and more world powers jump into a fierce competition to preoccupy emerging technologies. Technology environment has had changes such as shortened lifespan of technologies, survival allowed only to a top-notch technology, the developed countries' extended intervention in standardization or increased rivalry over intellectual property right (IPR). Industrial environment has also had changes like accelerated inter-industrial coalition by the digital convergence, or introduction of new industries by the development of new technologies.

The businesses have adopted proactive management to survive the competition by willingly adopting changes to the technology and industrial environments to meet the diversified and segmented customer needs. The success of the proactive management heavily depends on whether the research and development (R&D) can operate as the engine for growth in the next generation. The businesses now consider the R&D as one of the most important factors to consider in management, as technologies take wider portion in the business success.

The R&D has gone through evolution after evolution. The fourth-generation R&D, started from 1990 until today, emphasizes that a multitechnology-based innovation that integrates a variety of technologies can create more desirable result than by a unitechnology-based innovation. The collapse of the existing market governance following the introduction of global economy highlighted the need for a long-term R&D rather than short-term one, and the introduction of the complex and convergent science-based industries, such as information technology (IT), bio-technology, or future material made businesses realize that R&D is almost impossible by a single company, and that they need new ways of managements based on competition and cooperation to meet the changes like shortened product lifespan and increased importance of coalition research among the interested parties.

Against this backdrop, a need for the establishment and utilization of information analysis system has been recognized, which is the new scheme to discover emerging technologies efficiently using basic data based on the R&D related information and to save time and efforts for the R&D business.

However, the currently available information analysis system is limited to the simple statistic analysis that accumulates and shows according to fields the bibliographic data of the scholarly journals or theses, or the documents of the academic society. Such database only shows simple information such as number of authors, or term frequency categorized by a keyword. In other words, this simple statistic information does not provide any in-depth information about the technologies currently being developed or anticipated to be emerging in the future, or which technological fields are cooperating with each other, or which authors are working in which fields of technology.

Accordingly, a new information analysis system is required, which enables analysis of interrelation between the information included in the database and anticipation of pivotal technologies in the development of industry, thereby helping to discover the emerging technologies more easily and efficiently. At the same time, the new information analysis system should be able to determine cooperation between authors, countries, or institutes for more substantial approach in the technology research.

### SUMMARY

Several aspects and example embodiments of the present invention provide an information analysis system and/or method enabling analysis of the technological trends, emerging technologies, professional authors, inter-country cooperation, or inter-institutional cooperation.

According to an aspect of the present invention, an information analysis system is provided. The information analysis system includes a data loading unit to retrieve data from a document, a storage unit to store the data, a correlation analysis unit to compute at least one correlation index to represent the correlation between the data stored at the storage unit, and a mapping unit to show the correlation between the data on a map based on the correlation index.

According to another aspect of the present invention, a method for analyzing information is provided. In one exemplary embodiment, a method generally includes retrieving data from a document. The method may also include computing at least one correlation index by standardizing a simultaneous term frequency. The method may further include showing the correlation between the data on a map based on the correlation index.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a block diagram of an information analysis system according to an exemplary embodiment of the present invention;

FIG. 2 is a block diagram of an information analysis system according to a second exemplary embodiment of the present invention;

FIG. 3 is a block diagram of an information analysis system according to a third exemplary embodiment of the present invention;

FIG. 4 illustrates an exemplary matrix in which a simultaneous term frequency computed by the term frequency computing unit of FIG. 3;

FIG. 5 illustrates the exemplary result of statistical processing which includes a graphical representation constructed by the statistic analysis unit of FIG. 3;

FIG. 6 illustrates an exemplary initial screen of an information analysis program executed based on the information analysis program illustrated in FIG. 3;

FIG. 7 illustrates an exemplary window provided to a user upon data loading on the information analysis program illustrated in FIG. 6, to enable a user to select the fields of the bibliographical data;

FIG. 8 illustrates an exemplary screen when the information analysis program illustrated in FIG. 6 completes data loading;

FIG. 9 illustrates an exemplary selection screen through which words are selected for the cleansing by the cleaning unit illustrated in FIG. 1;

FIG. 10 illustrates an exemplary screen of a thesaurus editor; and

FIG. 11 illustrates an exemplary map constructed by the mapping unit illustrated in FIG. 1 according to an exemplary embodiment of the present invention.

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of exemplary embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness. The following description is merely exemplary in nature and is not intended to limit the present disclosure, application, or uses.

According to an aspect of the present invention, an information analysis system is provided. The information analysis system includes a data loading unit to retrieve data from a document, a storage unit to store the data, a correlation analysis unit to compute at least one correlation index to represent the correlation between the data stored at the storage unit, and a mapping unit to show the correlation between the data on a map based on the correlation index.

According to another aspect of the present invention, the correlation index is obtained by standardizing a simultaneous term frequency, the simultaneous term frequency representing a frequency of the data stored in the storage unit appearing in a document simultaneously.

According to another aspect of the present invention, the correlation index includes a correlation index obtained by standardizing a simultaneous term frequency, the simultaneous term frequency representing a frequency of the data stored in the storage unit appearing in a document simultaneously, or a correlation index to represent a similarity of technical field between the data stored in the storage unit.

According to another aspect of the present invention, the data includes one of the traits regarding titles, authors, search keywords, document titles, institutes where authors belong, publication dates, cited documents, author's countries, and technical classifications, and the storage unit stores the data in the categories of the traits.

According to another aspect of the present invention, the data loading unit counts the number of data that have the same content among the data of the same trait.

According to another aspect of the present invention, the mapping unit performs the mapping by adjusting the relative locations of the data on the map and representing a line that connects the data with a varying thickness.

According to another aspect of the present invention, the mapping unit adjusts the relative locations of the data based on the correlation index of the simultaneous term frequency which is obtained by standardizing the simultaneous term frequency, and varies the thickness of the line based on a technical field correlation index which represents a similarity of the technical field.

According to another aspect of the present invention, the mapping unit places the data having the higher correlation index of the simultaneous term frequency at closer locations than the data having the lower correlation index of the simultaneous term frequency.

According to another aspect of the present invention, the mapping unit draws a relatively thicker line between the data that have higher technical field correlation index than the data that have lower technical field correlation index.

According to another aspect of the present invention, the information analysis system further includes a cleansing unit to unify the terms of the data stored in the storage unit.

According to another aspect of the present invention, the information analysis system further includes a clustering unit to group the data stored in the storage unit according to a predetermined reference.

According to another aspect of the present invention, the mapping unit represents the data groups in the form of shapes on the map, and varies the sizes of the shapes according to the sizes of the groups.

According to another aspect of the present invention, if the data relates to a technology, the information analysis system further includes a technical growth analysis unit to compute a technical growth rate from the changes in a frequency of the data stored in the storage unit appearing in a document simultaneously, and to determine to which of a quickening period, a maturing period, or a recent surge the technology falls, based on the growth rate.

According to another aspect of the present invention, if the data relates to a technology, the information analysis system further includes a technical growth analysis unit to compute a technical growth rate from the changes in a frequency of the data stored in the storage unit appearing in a document simultaneously, to compute a number of documents that the data stored in the storage unit appear, and to determine to which of a quickening period, a maturing period, or a recent surge the technology falls, based on the growth rate and the number of documents.

According to another aspect of the present invention, a method for analyzing information is provided. In one exemplary embodiment, a method generally includes retrieving data from a document. The method may also include computing at least one correlation index by standardizing a simultaneous term frequency. The method may further include showing the correlation between the data on a map based on the correlation index.

According to various embodiments, an information analysis system analyzes externally retrieved data, and provides analysis program that is easy to operate by a user.

The constituent elements of an exemplary embodiment of an information analysis system will first be explained below, and then the process of operating the analysis program by the operations of those constituent elements will be explained.

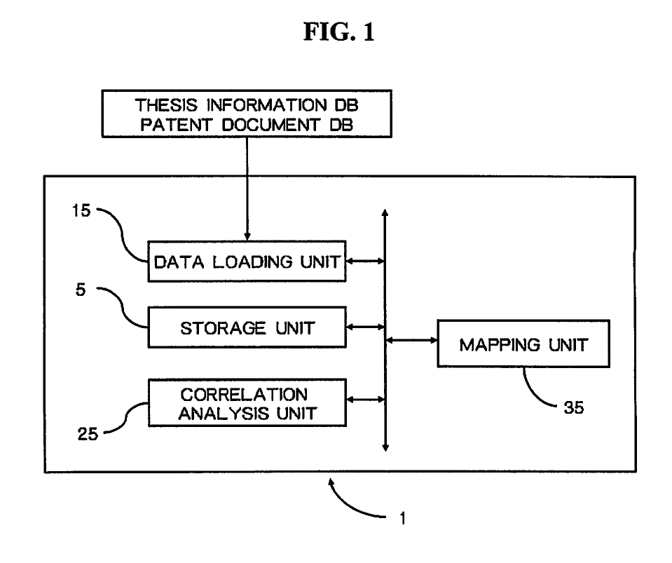

FIG. 1 illustrates the structure of an information analysis system according to an exemplary embodiment of the present invention.

The information analysis system 1 includes a data loading unit 15 to retrieve external data for analysis, a correlation analysis unit 25 to analyze correlation between the retrieved data, a mapping unit 35 to construct a map based on the result of analyzing at the correlation analysis unit 25, and a storage unit 5 to store the data retrieved by the data loading unit 15 and the result analyzed at the correlation analysis unit 25.

The data loading unit 15 retrieves: i) previously prepared database (DB); or ii) data-to-analyze from the websites accessible through networks. These data have certain attributes. For example, the data include bibliographic data and summary information such as text attribute. The bibliographic data may include a variety of attribute information such as titles, authors, keywords, names of scholarly journals, institution information, dates of publishing, cited references, countries, classifications of technical field, and/or unique numbers.

The storage unit 5 separately stores the data retrieved by the data loading unit 15 according to each type of attributes for the analysis of the data. For example, the storage unit 5 may store the data according to reference document. In this case, the storage unit 5 stores the data in a record unit, in which one data record includes at least one attribute field. The record unit corresponds to the technical reference, thesis, or patent document. Accordingly, one record is allocated for one piece of thesis, one record is allocated for one piece of technical reference, and one record is allocated for one piece of patent document.

Referring to table 1 provided below, data records are divided into three records, and each of the data records includes attributes fields such as a title field, author field, keyword field, and journal name field. The data loading unit 15 retrieves data preferably based on a record unit so that the storage unit 5 stores the retrieved data in the categories of records (that is, in the categories of reference documents) and attributes.

TABLE 1

| | | | | Journal name |
|---|---|---|---|---|
| Numbers | Title field | Author field | Keyword field | field |
| Thesis 1 | Nano | Kim et al. | Nano | abd*** |
| | technology . . . | | | |
| Thesis 2 | Trends of DNA | Park et al. | DNA chip | cde*** |
| | chips . . . | | | |
| Thesis 3 | Wibro . . . | Choi et al. | Wibro | fgh*** |

The data vary in the basis of record and thus are treated as the variables in the exemplary embodiment of the present invention. For example, the author field has variables of “Kim et al.”, “Park et al.”, and “Choi et al.” “Nano,” “DNA chip,” and “Wibro” are the variables of the keyword field.

Although each piece of thesis of Table 1 has one variable for one field, other alternatives are possible. For example, one piece of thesis may have two or more variables for one field. Referring to Table 2 provided below, each field has two subfields.

TABLE 2

| | | | | Keyword field | | Journal |
|---|---|---|---|---|---|---|
| | Title | Author field | | Subfield | | name |
| Number | field | Subfield 1 | Subfield 2 | 1 | Subfield 2 | field |
| Thesis 4 | **** | Kim et al. | Choi et al. | Nano | Protein | **** |
| Thesis 5 | &&&& | Lee et al. | | wibro | ubiquitous | $$$$ |

For one example, the author field may list author information about a plurality of authors therein by dividing the authors into subfields so that the storage unit 5 stores one author in one subfield.

Accordingly, a thesis having five keywords may create five keyword subfields, and the storage unit 5 stores the information in the categories of five keyword subfields. One author is allocated for one keyword subfield, and the full name of the allocated author, including his sub name and last name, is stored. As a result, it is possible to analyze the author from a plurality of different aspects.

If a thesis is the subject data of the analysis, the data loading unit 15 may retrieve the data from the Science Citation Index (SCI) or websites of scholarly journals or academic associations. If a patent document is the data to analyze, the data loading unit 15 may retrieve the data from the patent reference database that is provided by the organizations or agencies such as the Worldwide Intellectual Property Search (WIPS) (www.search,wips.co.kr), Korean Industrial Property Rights Information Service (KIPRIS) (www.kipris.or.kr), or United States Patent and Trademark Office (USPTO) (www.uspto.gov). In the exemplary embodiment explained below, the terms of “DB-to-analyze” refer to the data retrieved by the data loading unit 15 from the thesis DB or patent document DB and stored in the storage unit 5.

According to one aspect of the present invention, the data loading unit 15 may load the data of the pre-selected field only, from the thesis DB or patent document DB. For example, the pre-selected field may include a field regarding the subject field of the data, a field about an impact factor, or a field about a country. Herein, the terms “subject field of the data” refer to the field of technology to which the retrieved data belong. A user of the information analysis system may select the fields according to the exemplary embodiment of the present invention.

According to one aspect of the present invention, the data loading unit 15 may additionally have a statistical processing function to perform preliminary statistical processing of the DB-to-analyze that is retrieved from the selected DB or website. More specifically, the data loading unit 15 accumulates and counts the number of technical documents or authors belonging to each of the fields of the bibliographical data of the DB-to-analyze, and stores the counted value in the storage unit 5. For example, the data loading unit 15 may count the number of titles, authors, keywords, journals, institutions, publication dates, cited references, countries, technical classifications, or unique numbers. As a result, the DB-to-analyze specifically indicates how many titles are listed, how many keywords are used, how many authors are listed, or how many institutions wrote the thesis or patent document.

The data loading unit 15 may additionally count the same variables of the fields of the DB-to-analyze. More specifically, the data loading unit 15 may count the variables of the fields of the DB-to-analyze in a given category. For example, the data loading unit 15 may count how many times the same title has appeared, or how many thesis or patent documents were written by the same author, or how many times the same keyword, journal, institution, cited reference, country, technical classification, or unique number has appeared, based on the category of year. The information about the variables obtained by the counting at the data loading unit 15 may be provided to a user as the raw data.

While the data loading unit 15 has been used to perform statistical processing in the exemplary embodiments explained above, one will understand that the scope of the present invention will not be deviated if a structure devoted to the statistical processing is provided separately, or if one of the other structures such as the correlation analysis unit 25 which will be explained below, is used for the statistical processing. Furthermore, while the storage unit 5 stores the counted value in the exemplary embodiments explained above, one will understand that the information analysis system may employ a separate storage medium to store the counted values.

The correlation analysis unit 25 is capable of analyzing correlation between the data-to-analyze. The data-to-analyze include the data stored in the storage unit 5.

According to one aspect of the present invention, the correlation analysis unit 25 may derive the correlation index to represent the correlation between variables. The correlation index is the standardized index that represents the inter-variable correlation. The correlation index may include the standardized index of the simultaneous term frequency of two variables, or the correlation index that represents the correlation between two variables in consideration of data's other attributes such as technical field, institute, inventor, or keyword.

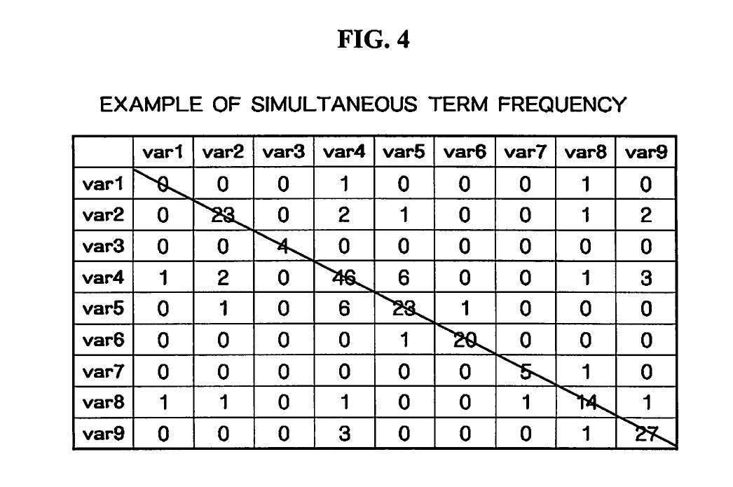

FIG. 4 illustrates an example of correlation being derived by the correlation analysis unit 25. Referring to FIG. 4, variables var1 and var1 appeared simultaneously for 9 times, variables var1 and var2 appeared simultaneously for 0 times, and variables var1 and var4 appeared simultaneously for 1 time. If var1 and var1 appeared simultaneously for 9 times, it means that variable var1 appeared in total 9 references, and if var1 and var4 appeared simultaneously for 1 time, it indicates that var1 and var4 simultaneously appeared in total 1 reference.

Accordingly, the correlation analysis unit 25 can compute the simultaneous term frequency of the variables. The correlation analysis unit 25 may additionally perform necessary data processing to represent the simultaneous term frequency of the variables in the form of matrix as illustrated in FIG. 4.

The variables analyzed by the correlation analysis unit 25 may be extracted from the same or difference fields.

For example, if the variables along the horizontal and vertical axes of FIG. 4 are extracted from the same field, like author field for example, the simultaneous term frequency in the matrix suggests how many times the authors cooperated with each other or co-wrote the documents. If the variables are extracted from the keyword field, which represents the technical field, the simultaneous term frequency of the matrix can suggest which technologies were combined and developed by coalition.

If the variables along the horizontal and vertical axes are extracted from different fields such as author field and keyword field, the simultaneous term frequency of the author and keyword can identify which author is working on which technical field. If the variables are extracted from the country and keyword fields, again, the data can indicate which country is researching which technology.

The correlation analysis unit 25 may standardize the simultaneous term frequency of the matrix to convert it into correlation index ranging from 0 to 1. For example, if the simultaneous term frequency ranges from 0 to 10000, the simultaneous term frequency 0 has 0 correlation index, and the simultaneous term frequency 10000 has 1 correlation index. In other words, the maximum value of the simultaneous term frequency has correlation index 1, 0 frequency has 0 correlation index, and the simultaneous term frequency in between is expressed in percentile between 0 and 1.

The standardization is conducted in consideration of the fact that the frequencies of simultaneous occurrence, ranging from 0 to thousands or even to tens of thousands may appear in the matrix depending on the size of the DB-to-analyze and thus cause excessive deviation. Excessive deviation deters an analyzer from determining the correlation solely based on the simultaneous term frequency. Therefore, by converting data into correlation index which ranges between 0 and 1, the analyzer can determine the correlation with ease, and the correlation index obtained from this can be used as a reference to indicate the correlation between the variables when a mapping is conducted at the mapping unit 35.

According to one aspect of the present invention, the correlation analysis unit 25 can derive other indexes based on other attributes of the data to represent the correlation. For example, the correlation analysis unit 25 may derive correlation index between variables in consideration of technical field, institute, inventor, or keyword.

The mapping unit 35 operates to map the variables based on the correlation indexes obtained at the correlation analysis unit 25.

The mapping process includes determining relative locations of the variables on the map and representing the correlativity between the variables in the form of a line.

Based on the correlation indexes obtained at the correlation analysis unit 25, the mapping unit 35 arranges the variables of higher correlativity in closer locations, while putting the lower-correlative variables at distances.

Accordingly, the relative locations of the variables are determined based on the correlation indexes obtained by the correlation analysis unit 25. For example, it is assumed that the mapping unit 35 represents variables var1, var2 and var3 on a map. If the correlation analysis unit 25 obtains correlation index 0.3 between var1 and var2, obtains 0.4 between var2 and var3, and obtains 0.5 between var3 and var1, the mapping unit 35 arranges var1 and var3 at closest locations, var2 and var3 at second-closest locations, and var1 and var2 at farthest locations. For example, var1 and var3 may be arranged at 3 cm distance, var2 and var3 at 4 cm distance, and var1 and var2 at 5 cm distance.

The mapping unit 35 connects a line between the variables and indicates the correlativity between the variables by varying the thickness of the connecting line. The mapping unit 35 may use the standardized simultaneous term frequency to determine the thickness of the connecting line.

For example, the mapping unit 35 can connect a line between the variables during mapping process, and vary the thickness of the connecting line according to the correlativity between the variables. In other words, the mapping unit 35 varies the thickness of the line based on the correlation indexes. The mapping unit 35 may draw the thinnest line between the variables that have correlation index 0, and draw the thickest line between the variables that have correlation index 1. The mapping unit 35 may increase the thickness of the line as the correlation indexes of the variables increase. According to one aspect of the present invention, the standardized simultaneous term frequency is used as the correlation index to determine the thickness of the line. The mapping unit 35 adjusts the thickness of the line connecting the variables based on the standardized simultaneous term frequency.

According to one aspect of the present invention, the mapping unit 35 uses the simultaneous term frequency of two variables as the correlation index to determine the thickness of the line, while using similarity between the corresponding technical fields of the two variables as the correlation index to determine the relative locations of these variables. This example will be explained in greater detail below, in which the mapping unit 35 maps two search keywords. In the example explained below, the mapping unit 35 will arrange the two keywords far away from each other on the map if the two keywords belong to different technical fields, places the keywords close to each other if the keywords belong to similar technical fields, and vary the thickness of a line that connects the two keywords depending on the frequency of the keywords appearing simultaneously in the same technical reference such as a thesis.

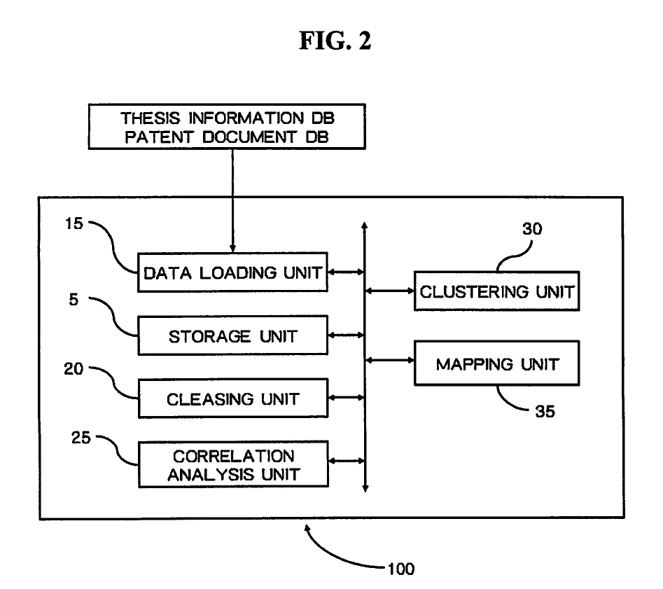

FIG. 2 is a block diagram of an information analysis system according to a second exemplary embodiment of the present invention.

The information analysis system 100 includes a data loading unit 15 to retrieve from outside the data-to-analyze, a cleansing unit 20 to unify data terms, a correlation analysis unit 25 to analyze correlation between variables-to-analyze, a clustering unit 30 to cluster variables having similarity, a mapping unit 35 to construct a map based on the result of analysis at the correlation analysis unit 25, and a storage unit 5 to store the data retrieved by the data loading unit 15 and the result of analysis obtained at the respective units.

The data loading unit 15, storage unit 5, correlation analysis unit 25 and mapping unit 35 are the same as those of the first exemplary embodiment explained above with reference to FIG. 1, so the overlapping units or operations will be omitted as much as possible for the sake of brevity.

The cleansing unit 20 performs revision process in which terms of variables in each field included in the DB-to-analyze are unified. The cleaning unit 20 may cover all the fields selected by a user and be used to unify particularly the terms such as keywords, institutes, names of scholarly journals, or countries.

For example, the data loading unit 15 counts the terms of AN and access network as separate keywords, although these terms have the same meaning with each other. The cleaning unit 20 perceives AN and access network as having the same meaning, and thus unifies these two terms into one term. The data loading unit 15 may conduct the counting of the data which are automatically cleansed periodically or nonperiodically. Alternatively, the data loading unit 15 may perform the counting of the data which are cleansed according to a user command, thereby updating the counting.

Accordingly, the cleaning unit 20 can unify the words like Ultra-wideband[UWB], UWB, Ultra-wideband, ultrawideband[UWB] and Ultra wideband, which have the same meaning, but are simply varied by the spacing, abbreviation, or dash, into one word.

The cleaning unit 20 may use the thesaurus to unify the terms. The thesaurus herein refers to database composed of words and synonyms for search and retrieval. According to one aspect of the present invention, the thesaurus may be established separately on the basis of the fields such as the countries, institutes, or keywords. The cleaning unit 20 unifies the terms in each field included in the search information of the DB-to-analyze, using the thesaurus. The thesaurus may be established by the thesaurus algorithms such as simple matches, escape sequences, character classes, metacharacters, or perl extensions.

As the cleaning unit 20 unifies the terms, more accurate information can be output in later processing such as mapping or statistic processing.

The correlation analysis unit 25 operates with respect to the cleansed data.

The clustering unit 30 compares traits of the DB-to-analyze and clusters, computes similarity and allocates clusters. Various measures may be used to determine the similarity, including Euclidean distance measure to calculate difference between the subjects based on the differences in vector space, or a similarity coefficient measure to calculate correlation between the traits expressed by the subjects.

The clustering unit 30 may use various clustering measures such as hierarchical clustering or non-hierarchical clustering.

The hierarchical clustering includes a single linkage, complete linkage, group average linkage, or Ward's method.

The non-hierarchical clustering measures similarity through a couple of initially generated random centoides and may have different results according to the initial selection of clusters. The order in which the clusters are input is important particularly in a single pass as this only has one arrangement.

The non-hierarchical clustering may use algorithms such as a single pass, K-means, or expectation maximization (EM) algorithm.

The clustering unit 30 may use a clustering measure based on similarity between variables using a matrix generated by the correlation analysis unit 25, in which case the variables having high similarity are clustered with each other.

After the clustering unit 30 finishes clustering, a plurality of variables is categorized into a plurality of groups, and one of the variables each group becomes a representative variable. The representative variable is later indicated on a map constructed by the mapping unit 35.

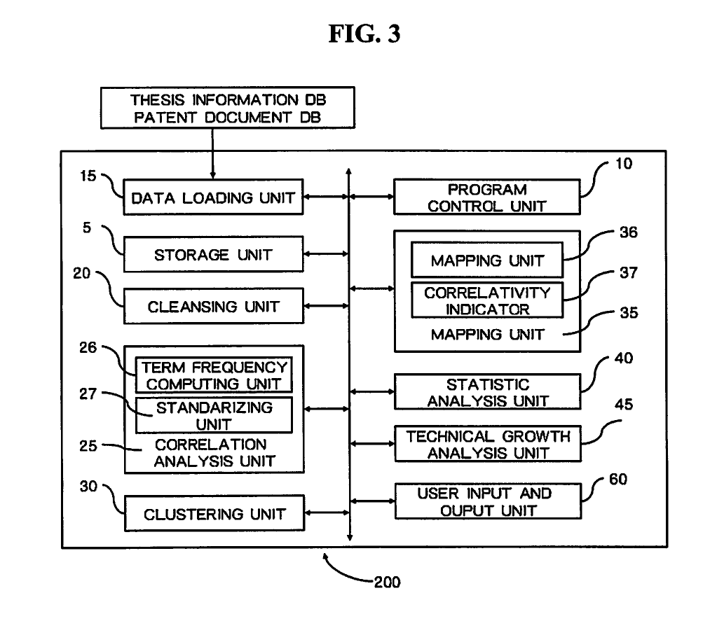

FIG. 3 is a block diagram of an information analysis system according to a third exemplary embodiment of the present invention.

The information analysis system 1 includes a data loading unit 15 to retrieve from outside the data-to-analyze, a cleansing unit 20 to unify data terms, a correlation analysis unit 25 to analyze correlation between variables-to-analyze, a clustering unit 30 to cluster variables having similarity, a mapping unit 35 to construct a map based on the result of analysis at the correlation analysis unit 25, a statistic analysis unit 40 provided for technical statistic analysis, a technical growth analysis unit 45 to analyze growth and prospects of technology, a storage unit 5 to store the data retrieved by the data loading unit 15 and the result of analysis obtained at the respective units, a program control unit 10 to control programs and provide the results of program operations and data analysis, and a user input and output unit 60.

The overlapping units or operations with those explained above with reference to FIGS. 1 and 2 will not be explained below for the sake of brevity.

According to one aspect of the present invention, the correlation analysis unit 25 derives correlativity between variables-to-analyze. The correlation analysis unit 25 includes a term frequency computing unit 26, and a standardizing unit 27.

Referring to FIG. 4, the term frequency computing unit 26 computes simultaneous term frequency of the variables-to-analyze. As explained above, the variables may be extracted from the same or different fields.

The standardizing unit 27 standardizes the simultaneous term frequency to convert into correlation index ranging between 0 and 1.

According to one aspect of the present invention, the correlation analysis unit 25 may additionally include a technical similarity computing unit (not illustrated).

The technical similarity computing unit computes technical similarity between the variables. The standardizing unit 27 not only standardizes the simultaneous term frequency and converts into correlation index between 0 and 1, but may also standardize the technical similarity computed at the technical similarity computing unit and convert it into correlation index ranging between 0 and 1.

The clustering unit 30 may adopt a clustering measure to group the variables that have high correlativity, based on the similarity generated at the term frequency computing unit 26. On the alternative, the clustering unit 30 may cluster the variables based on both the correlation indexes generated at the term frequency computing unit 26 and the correlation indexes generated at the technical similarity computing unit.

The mapping unit 35 maps the variables based on the correlativity standardized at the correlation analysis unit 25. The mapping unit 35 includes a mapper 36 and a correlation indicator 37.

The mapping unit 36 arranges the variables on a map according to correlativity between the variables. That is, variables having higher correlative are arranged closer to each other, while variables having lower correlativity are arranged further away from each other. According to one aspect of the present invention, the mapping unit 36 determines the relative locations of the variables using the correlation indexes based on the technical similarity.

The correlation indicator 37 determines the thickness of a line to represent the correlativity between the variables according to the correlation indexes analyzed at the correlation analysis unit 25 and indicates the result. The correlation indicator 37 may vary the thickness of the line depending on the correlation indexes. That is, the correlation indicator 37 may determine the thickness of the line using the correlation indexes based on the simultaneous term frequency.

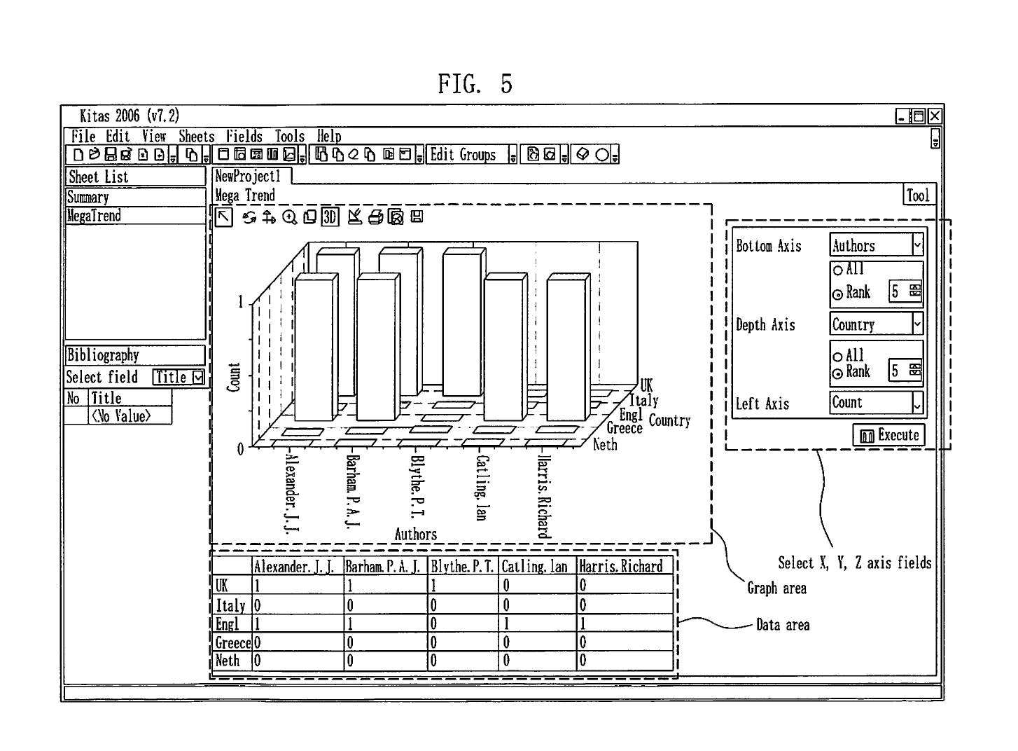

Referring to FIG. 5, the statistic analysis unit 40 generates a three-dimensional (3D) graph from a field selected by an analyzer, and performs statistical function to tabulate the data about the graph. The statistical analysis may use almost all the fields included in the DB-to-analyze, such as publication dates, countries, authors, institutions, keywords, case numbers, or citations. The statistic analysis unit 40 may employ the same measures used by the general statistic programs which are generally known, and so the detailed description of this unit will be omitted for the sake of brevity.

The technical growth analysis unit 45 computes a growth rate to represent the changes of technology that are taking place in the categories of authors, years, countries, technical fields, or institutions. The growth rate indicates the technical trends. The technical trends may indicate that the technology is in the quickening period, maturing stage, or recent surge.

The technical growth analysis unit 45 may determine the technical field of an author, and technical trends in the categories of years, countries, technical fields, institutions.

For example, the technical field in the country category may be obtained by comparing the country field with the keyword field to subsequently compute simultaneous term frequency of the country and the keyword, and dividing a simultaneous term frequency of a certain keyword with respect to each country by a simultaneous term frequency of the certain keyword with respect to the entire countries and computing growth rates. By computing the growth rates for each year, trend in the research of a corresponding technology in each country is analyzed.

The stages of developments such as quickening period, maturing period or recent surge are applicable based on the growth rates. For example, the quickening period applies when the growth rate above a certain level is found for the first time, the maturing period applies when the growth rate maintains above a certain level since the quickening period, and the recent surge applies when the growth rate has rapidly increased above a certain level since the previous year. However, one will understand that a user or a designer may always change the growth rate that corresponds to the quickening period, maturing period or recent surge appropriately.

As explained above, the changes occurring in the technical trend depending on the authors, year, countries, technical fields, or institutes are analyzed easily, by determining the quickening period, maturing period, or recent surge based on the growth rate. As a result, technical trend and the direction of the technology are analyzed, and prospect technology is analyzed easily.

The technical growth analysis unit 45 may determine the technical trends using at least two information, including: i) growth rate, and ii) number of references. For example, the technical growth analysis unit 45 determines a subject technology to be in the quickening period if its growth rate and number of references are relatively low but on the gradual increase. The technical growth analysis unit 45 may determine the technology to be in the maturing period if its growth rate and number of references stay stable, and determine the recent surge if the growth rate and number of references has increased significantly.

The program control unit 10 controls the information analysis program to provide the information analysis program on a user's screen, to drive the elements of the information analysis system 200 according to the user selection input through the user input and output unit 60, and to display the result of driving on the screen through the user input and output unit 60.

The process of running the information analysis program and thus operating the information analysis system 200 will be explained below.

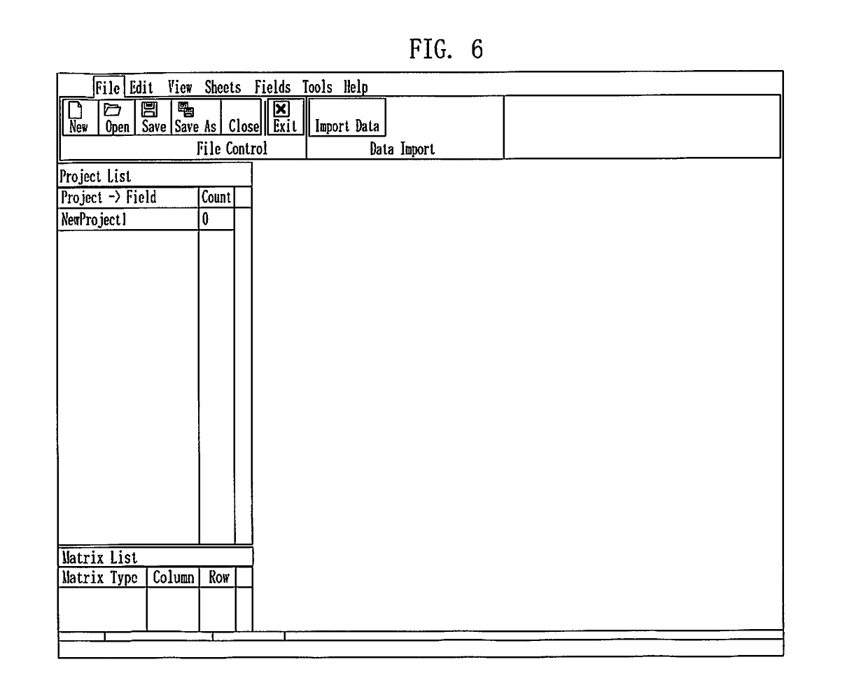

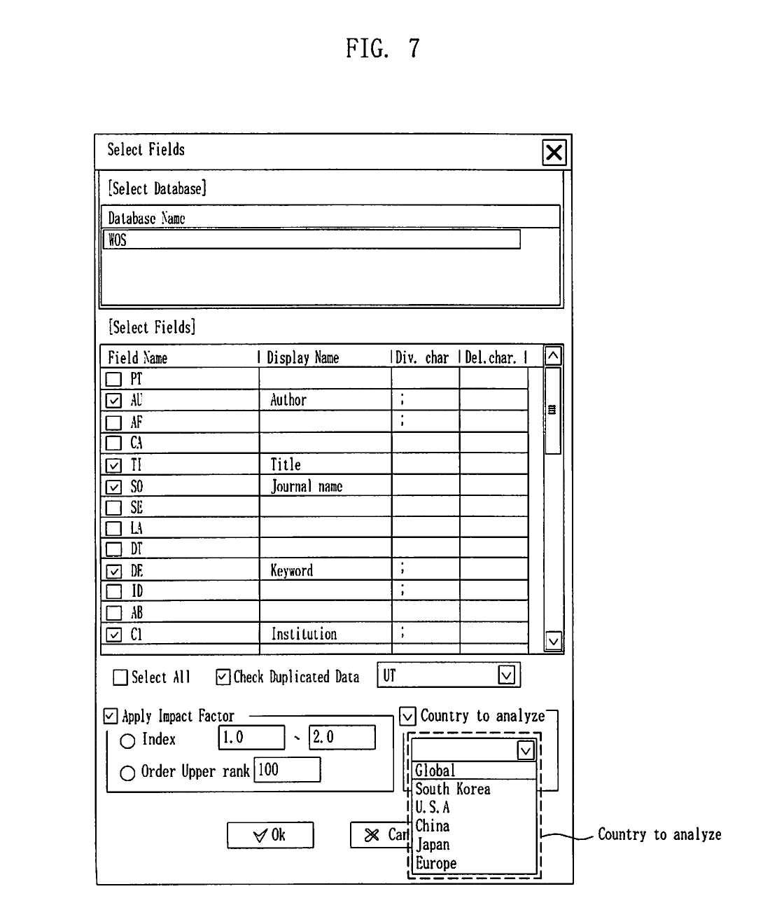

Upon executing the information analysis program based on the information analysis system 200 according to the exemplary embodiments of the present invention, an initial screen appears as illustrated in FIG. 6. Upon selecting ‘import data’ button to load data in the initial screen, a screen is provided, enabling a user to select a DB or website to retrieve data. After the selection of data source, referring to FIG. 7, a window appears, through which a user can select the bibliographical data field to retrieve from the selected DB or website. If the retrieved data is a thesis, a user may select the impact factor (IF) by index or order, and may also select a country to analyze.

As the user selects the DB or website and determines IF and selects countries, the data loading unit 15 retrieves data from a corresponding DB or website according to the user's selected conditions and generates a DB-to-analyze.

After completion of data loading, or in the middle of data loading, or by a user command, the data loading unit 15 may count the fields included in the bibliographical information and summary respectively.

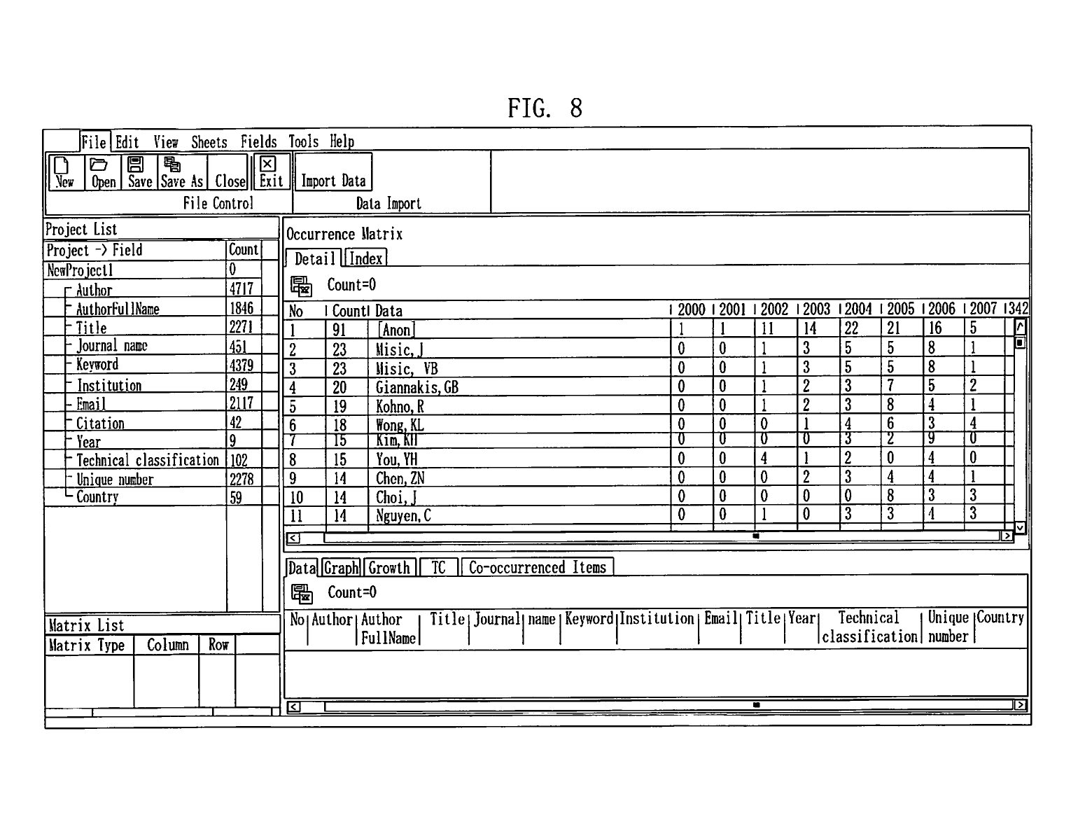

Upon completion of the counting, a project list appears as illustrated in FIG. 8. The project list places the respective fields of the DB-to-analyze in different rows, and indicates the number of the fields. If one of the fields is selected, the right side window shows the number of variables of the selected field orderly in the category of years.

For example, if a keyword is selected from the project list, a detailed list appears, in which keywords like Bluetooth and Ultra-wideband[UWB] are listed orderly according to the number of occurrences, and indicated by the number of occurrences such as 229 and 160.

Underneath the detailed list appears a graph button to select a graph to represent the term frequency of the variables of the selected field in the category of year, and a growth button to selectively indicate from among the quickening period, maturing period, and recent surge according to the growth rate.

When the data loading is completed, the cleaning is processed to unify the terms of the variables having the same meaning.

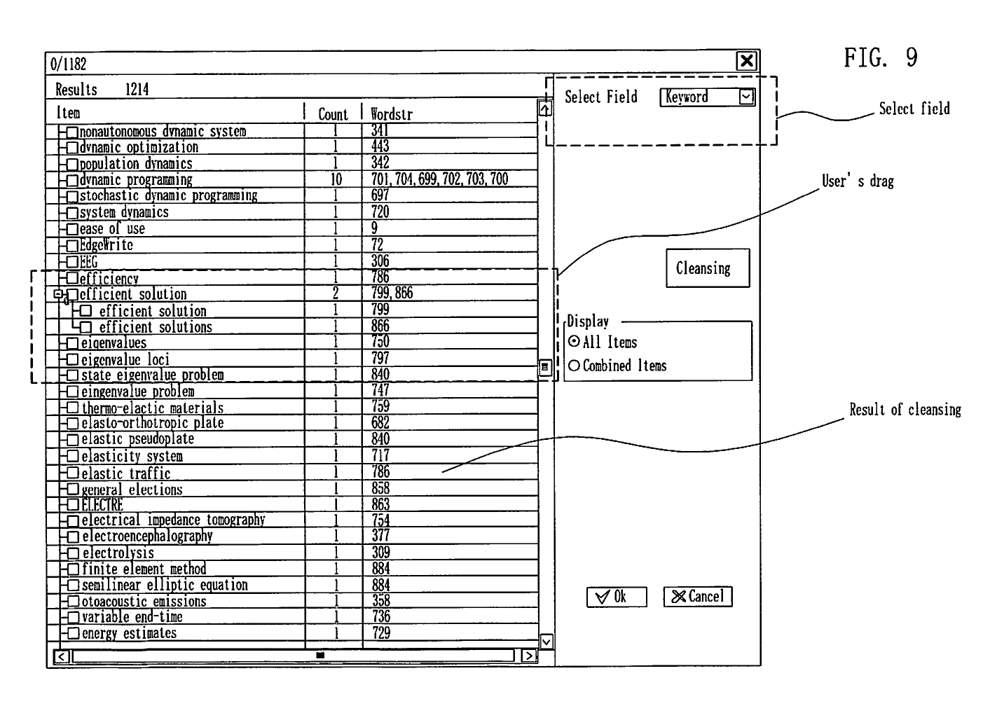

A user may select whether or not to perform the cleansing. Accordingly, a cleaning selection screen may be provided to the user as illustrated in FIG. 9. If a user selects a field to cleanse, the terms of the corresponding field appear and the cleansing unit 20 unifies the terms of the corresponding field. The user may use a mouse to directly drag a term to edit.

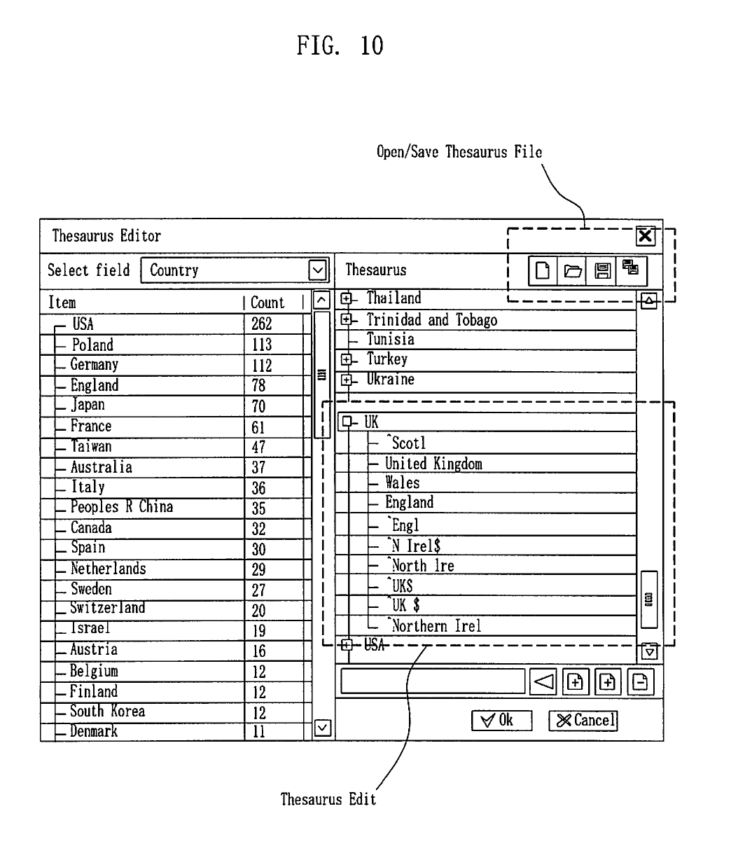

A thesaurus editor may also be provided as illustrated in FIG. 10 so that a user can directly edit the thesaurus. On the left side of the thesaurus editor are listed the terms of the corresponding field, and on the right side, the thesaurus of the selected term is displayed. The user may edit the thesaurus by adding or deleting. The terms edited by the user are updated in the thesaurus, and applied in the next driving of the cleansing unit 20.

The clustering starts after the cleansing. The clustering may be skipped if a user selects so or if there are not so many variables. If a clustering function is selected regarding a certain field, the clustering unit 30 clusters the variables of the corresponding field using the predetermined clustering measure.

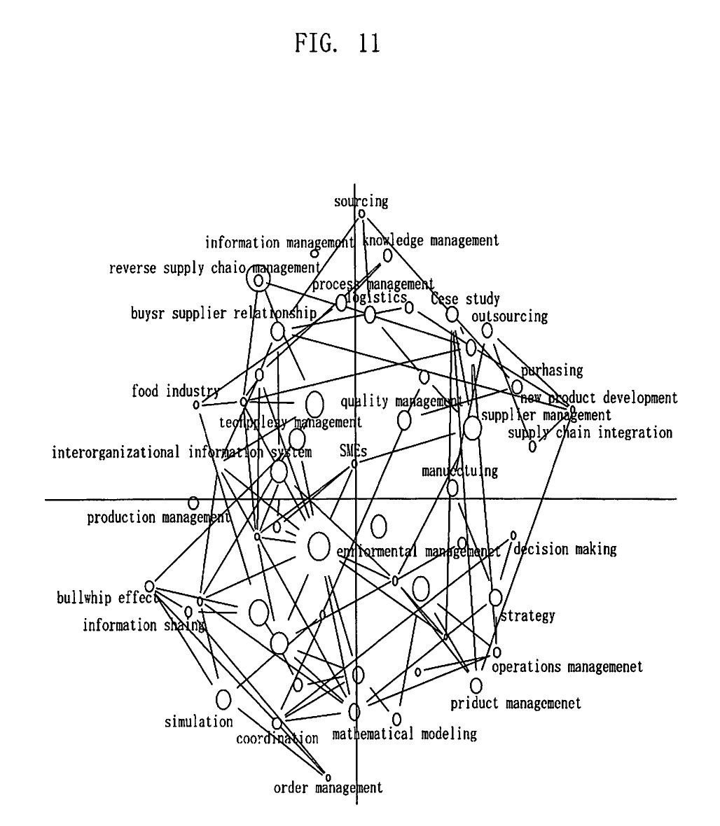

If a user selects a field to indicate as a map from the project list illustrated in FIG. 8, the mapping unit 35 sets the locations of the respective variables of the field and draws a line between the variables and determines the thickness of the line using the correlation indexes computed at the correlation analysis unit 25. As a result, a map appears as illustrated in FIG. 11.

If a user clicks the growth button illustrated in FIG. 8, a screen appears, through which the quickening period, maturing period or recent surge can be selected. If a user selects one of these periods, the technical growth analysis unit 45 computes the growth rate of each of the variables of the selected field, and provides the information about the selected field such as countries, technologies, institutions or authors that belong to the selected period, based on the computed growth rate.

When introducing elements or features and the exemplary embodiments, the articles “a”, “an”, “the” and “said” are intended to mean that there are one or more of such elements or features. The terms “comprising”, “including” and “having” are intended to be inclusive and mean that there may be additional elements or features other than those specifically noted. It is further to be understood that the method steps, processes, and operations described herein are not to be construed as necessarily requiring their performance in the particular order discussed or illustrated, unless specifically identified as an order of performance. It is also to be understood that additional or alternative steps may be employed.

While certain exemplary embodiments of the present invention have been shown and described with reference to certain preferred embodiments thereof, it will be understood by those skilled in the art that various changes in form and details may be made therein without departing from the spirit and scope of the invention as defined by the appended claims and their equivalents.

What is claimed is:

1. An information analysis system comprising:
a data loading unit to retrieve data from a document;
a storage unit to store the data;
a correlation analysis unit to compute at least one correlation index to represent the correlation between the data stored at the storage unit; and
a mapping unit to show the correlation between the data on a map based on the correlation index.

2. The information analysis system of claim 1, wherein the correlation index is obtained by standardizing a simultaneous term frequency, the simultaneous term frequency representing a frequency of the data stored in the storage unit appearing in a document simultaneously.

3. The information analysis system of claim 1, wherein the correlation index comprises:
a correlation index obtained by standardizing a simultaneous term frequency, the simultaneous term frequency representing a frequency of the data stored in the storage unit appearing in a document simultaneously; or
a correlation index to represent a similarity of technical field between the data stored in the storage unit.

4. The information analysis system of claim 1, wherein the data comprises at least one trait selected from the group consisting of a title, an author, a search keyword, a document title, an institute where an author belongs, a publication date, a cited document, an author's country, and a technical classification, and
the storage unit stores the data in the corresponding categories of the traits.

5. The information analysis system of claim 4, wherein the data loading unit counts the number of data that have the same content among the data of the same trait.

6. The information analysis system of claim 3, wherein the mapping unit performs the mapping by adjusting the relative locations of the data on the map and representing a line that connects the data with a varying thickness.

7. The information analysis system of claim 6, wherein the mapping unit adjusts the relative locations of the data based on the correlation index of the simultaneous term frequency which is obtained by standardizing the simultaneous term frequency, and varies the thickness of the line based on a technical field correlation index which represents a similarity of the technical field.

8. The information analysis system of claim 7, wherein the mapping unit places the data having the higher correlation index of the simultaneous term frequency at closer locations than the data having the lower correlation index of the simultaneous term frequency.

9. The information analysis system of claim 6, wherein the mapping unit draws a relatively thicker line between the data that have higher technical field correlation index than the data that have lower technical field correlation index.

10. The information analysis system of claim 1, further comprising a cleansing unit to unify the terms of the data stored in the storage unit.

11. The information analysis system of claim 1, further comprising a clustering unit to group the data stored in the storage unit according to a predetermined reference.

12. The information analysis system of claim 11, wherein the mapping unit represents the data groups in the form of shapes on the map, and varies the sizes of the shapes according to the sizes of the groups.

13. The information analysis system of claim 1, further comprising a technical growth analysis unit to compute a technical growth rate from the changes in a frequency of the data stored in the storage unit appearing in a document simultaneously, and to determine to which of a quickening period, a maturing period, or a recent surge the technology falls, based on the growth rate.

14. The information analysis system of claim 1, further comprising a technical growth analysis unit to compute a technical growth rate from the changes in a frequency of the data stored in the storage unit appearing in a document simultaneously, to compute a number of documents that the data stored in the storage unit appear, and to determine to which of a quickening period, a maturing period, or a recent surge the technology falls, based on the growth rate and the number of documents.

15. A method for analyzing information comprising:
retrieving data from a document;
computing at least one correlation index by standardizing a simultaneous term frequency; and
showing the correlation between the data on a map based on the correlation index.

16. The method of claim 15, wherein the data comprises at least one trait selected from the group consisting of a title, an author, a search keyword, a document title, an institute where an author belongs, a publication date, a cited document, an author's country, and a technical classification

17. The method of claim 15, wherein the showing comprises adjusting the relative locations of the data on the map and representing a line that connects the data with a varying thickness.

18. The method of claim 17, wherein the adjusting comprises adjusting the relative locations of the data based on the correlation index of the simultaneous term frequency which is obtained by standardizing the simultaneous term frequency, and varying the thickness of the line based on a technical field correlation index which represents a similarity of the technical field.
